(19) United States
(12) Patent Application Publication
(10) Pub. No.: US 2006/0222225 A1
(43) Pub. Date: Oct. 5, 2006

(54) Image processing apparatus, image processing method and image processing program

(75) Inventor: Akira Kurahashi, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/390,784

(22) Filed: Mar. 28, 2006

(30) Foreign Application Priority Data
Mar. 30, 2005 (JP) 2005-097781

(51) Int. Cl. G06K 9/00

(52) U.S. Cl. 382/128

(57) ABSTRACT

An image processing apparatus includes: an image storing section to store images imaged by modalities; an image selecting section to allow a user to select an image to be displayed out of images stored in the image storing section; an image processing condition storing section to store a plurality of different kinds of image processing conditions; an image processing section to execute image processing by application of the plurality of different kinds of image processing conditions to selected image; and a display controlling section to switch each of images generated by image processing, under application of the plurality of different kinds of image processing conditions to the selected image, and to display it on the same display screen.

### BACKGROUND OF THE INVENTION

1. Field of the Invention

The present invention relates to an image processing apparatus, an image processing method, and an image processing program, which displays an image on a display screen for a doctor to diagnose through image interpretation.

2. Description of the Related Art

In the field of medical care, digitization of a medical image taken by imaging a patient (subject) has been put into practice. Medical image processing apparatus have been developed for obtaining image data that are generated from modalities (medical image generating apparatus) and digitized, applying various image processing to the obtained image data, and displaying the result on a display means such as an LCD (liquid crystal display), or outputting the result on a film. The modalities include CR (computed radiography) apparatus, CT (computed tomography) apparatus, MRI (magnetic resonance imaging) apparatus, reading apparatus for reading an X-ray image recorded on an X-ray film, ultrasonic imaging apparatus, and the like.

In the diagnosis based on medical images, images subject to comparison are often displayed in parallel, and compared with each other. For instance, in order to determine progress or recovery of lesion, an image displaying apparatus that simultaneously displays a plurality of images including images of time-series of the same region of a same examinee taken at different points of time, has been proposed (see, for example, JP 2003-220057 A). There is also been proposed an image outputting method that, according to information on a density difference between two original images taken at different points of time of a same subject, applies subtraction processing to every pixel of the original images, and switches output and not-output of the obtained subtraction image over time (see, for example, JP 2002-74359 A). By omitting the output of the elapse subtraction image over time in case the change over time is little, efficiency of interpretation task can be improved.

In addition, there is a case where different image processing is applied to the same image and compared with each other.

However, according to the above-described conventional technique, it has been sometimes difficult to recognize which portion of images is to be focused when interpreting the plurality of images subject to comparison.

### SUMMARY OF THE INVENTION

The present invention has been developed in view of the above-described problem in the conventional technique. An object of the invention is to provide an image processing apparatus, an image processing method and an image processing program for improving efficiency of image interpretation.

In order to solve the above-described problem, according to the first aspect of the invention, an image processing apparatus comprises: an image storing section to store images imaged by modalities; an image selecting section to allow a user to select an image to be displayed out of images stored in the image storing section; an image processing condition storing section to store a plurality of different kinds of image processing conditions; an image processing section to execute image processing by application of the plurality of different kinds of image processing conditions to selected image; and a display controlling section to switch each of images generated by image processing, under application of the plurality of different kinds of image processing conditions to the selected image, and to display it on the same display screen.

According to the first aspect of the invention, the apparatus executes image processing under a plurality of different kinds of image processing conditions to the selected image, and displays each of the images that were image processed under a plurality of different kinds of image processing conditions on the same display screen, within switching each of the images. This allows the user to more easily recognize the difference between the images due to the difference between image processing conditions, and to improve the efficiency of image interpretation.

Preferably, the plurality of different kinds of image processing conditions comprise at least either of frequency processing conditions or tone processing conditions.

According to this invention, each of the images, applied with different image processing conditions of either frequency processing conditions or tone processing conditions, can be displayed on the same display screen within switching.

Preferably, the image processing apparatus further comprises an image processing condition inputting section to allow the user to selectively input image processing conditions to be used out of the plurality of different kinds of image processing conditions.

According to this invention, image processing can be applied to the selected image using the image processing conditions selectively inputted by the user out of the plurality of image processing conditions.

The image processing apparatus may further comprise a switching instruction section to instruct switching of each of the images generated by image processing, wherein the display controlling section switches each of the images generated by image processing based on a switching instruction from the switching instruction section and displays it on the same display screen.

According to this invention, each of the images applied with image processing can be displayed on the same display screen within switching, based on the switching instruction.

The display controlling section may switch each of the images generated by image processing in a predetermined time interval and display it on the same display screen.

According to this invention, each of the images applied with image processing can be displayed on the same display screen within switching, in the predetermined time interval.

According to the second aspect of the invention, an image processing method comprises: an image storing step to store images imaged by modalities; an image selecting step to allow a user to select an image to be displayed out of stored images; an image processing condition storing step to store a plurality of different kinds of image processing conditions; an image processing step to execute image processing by application of the plurality of different kinds of image processing conditions to selected image; and a display controlling step to switch each of images generated by image processing, under application of the plurality of different kind of image processing conditions to the selected image, and to display it on the same display screen.

According to the second aspect of the invention, the apparatus executes image processing under a plurality of different kinds of image processing conditions to the selected image, and displays each of the images that were image processed under a plurality of different kinds of image processing conditions on the same display screen, within switching each of the images. This allows the user to more easily recognize the difference between the images due to the difference between image processing conditions, and to improve the efficiency of image interpretation.

Preferably, the plurality of different kinds of image processing conditions comprise at least either of frequency processing conditions or tone processing conditions.

According to this invention, each of the images, applied with different image processing conditions of either frequency processing conditions or tone processing conditions, can be displayed on the same display screen within switching.

Preferably, the image processing method further comprises an image processing condition inputting step to allow the user to selectively input image processing conditions to be used out of the plurality of different kinds of image processing conditions.

According to this invention, image processing can be applied to the selected image using the image processing conditions selectively inputted by the user out of the plurality of image processing conditions.

At the display controlling step, each of the images generated by image processing may be displayed on the same display screen within switching, based on a switching instruction from a switching instruction section that instructs switching of each of the images generated by image processing.

According to this invention, each of the images applied with image processing can be displayed on the same display screen within switching, based on the switching instruction.

At the display controlling step, each of the images generated by image processing may be switched in a predetermined time interval and displayed on the same display screen

According to this invention, each of the images applied with image processing can be displayed on the same display screen within switching, in the predetermined time interval.

According to the third aspect of the invention, an image processing program that causes a computer to execute a process comprises: an image selecting step to allow a user to select an image to be displayed out of images imaged by modalities and stored in an image storing section; an image processing step to execute image processing by application of a plurality of different kinds of image processing conditions stored in an image processing condition storing section to the selected image; and a display controlling step to switch each of images generated by image processing, under application of the plurality of different kinds of image processing conditions to the selected image, and to display it on the same display screen.

According to the third aspect of the invention, the apparatus executes image processing under a plurality of different kinds of image processing conditions to the selected image, and displays each of the images that were image processed under a plurality of different kinds of image processing conditions on the same display screen, within switching each of the images. This allows the user to more easily recognize the difference between the images due to the difference between image processing conditions, and to improve the efficiency of image interpretation.

Preferably, the plurality of different kinds of image processing conditions comprise at least either of frequency processing conditions or tone processing conditions.

According to this invention, each of the images, applied with different image processing conditions of either frequency processing conditions or tone processing conditions, can be displayed on the same display screen within switching.

Preferably, the image processing program further causes the computer execute a process of an image processing condition inputting step to allow the user to selectively input image processing conditions to be used out of the plurality of different kinds of image processing conditions.

According to this invention, image processing can be applied to the selected image using the image processing conditions selectively inputted by the user-out of the plurality of image processing conditions.

At the display controlling step, each of the images generated by image processing may be displayed on the same display screen within switching, based on a switching instruction from a switching instruction section that instructs switching of each of the images generated by image processing.

According to this invention, each of the images applied with image processing can be displayed on the same display screen within switching, based on the switching instruction.

At the display controlling step, each of the images generated by image processing may be switched in a predetermined time interval and displayed on the same display screen.

According to this invention, each of the images applied with image processing can be displayed on the same display screen within switching, by the predetermined time interval.

### BRIEF DESCRIPTION OF THE DRAWINGS

The present invention will become more fully understood from the detailed description given below and the accompanying drawings, which are not intended to limit the present invention, and wherein:

FIG. 1 is a block diagram showing the functional configuration of an image processing apparatus 10 according to an embodiment of the present invention;

FIG. 2 is a flowchart showing an image displaying process executed by CPU 11 of the image processing apparatus 10;

FIG. 3A shows an example of image that was generated with application of weak tone processing condition, among application of different tone processing conditions;

FIG. 3B shows an example of image that was generated with application of strong tone processing condition, among application of different tone processing conditions;

FIG. 4A shows an example of image that was generated with application of weak frequency processing condition, among application of different frequency processing conditions; and

FIG. 4B shows an example of image that was generated with application of strong frequency processing condition, among application of different frequency processing conditions.

### PREFERRED EMBODIMENT OF THE INVENTION

Hereinafter, an image processing apparatus according to a preferred embodiment of the invention will be described with reference to the accompanying drawings.

First, the configuration of the apparatus will be described.

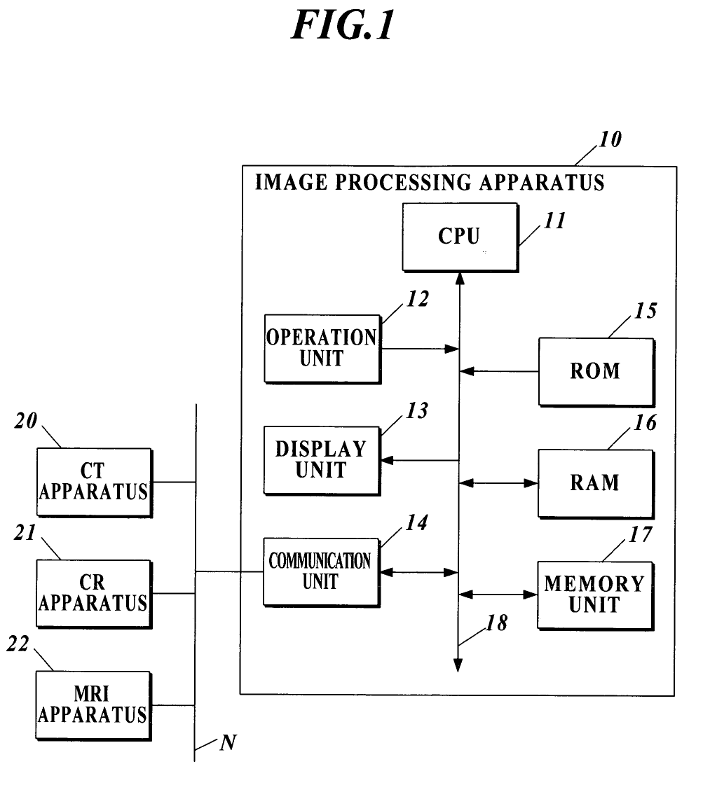

FIG. 1 shows the functional configuration of the image processing apparatus 10 according to the embodiment. As shown in FIG. 1, the apparatus 10 includes CPU (central processing unit) 11, operation unit 12, display unit 13, communication unit 14, ROM (read only memory) 15, RAM (random access memory) 16, and memory unit 17, and each unit is connected with each other through a bus 18.

The CPU 11 spreads programs and data stored in the ROM 15 in a temporary memory area of the RAM 16, and controls the entire apparatus according to the programs. Further, the CPU 11 reads out image data stored in the memory unit 17, executes image processing to the image data read out, and displays the image data applied with image processing and the like on the display 13.

Specifically, CPU 11 executes image processing under a plurality of different kinds of image processing conditions to an image selected by a user, and displays on a same display screen of the display unit 13 each of the images applied with the plurality of different kinds of image processing conditions, within switching each of the images.

The operation unit 12 includes pointing devices, such as a keyboard having cursor keys, numeric-character input keys and various function keys, and a mouse; and a switching button (none of them are shown) to instruct the switching of each of the images generated by image processing, under the plurality of different kinds of image processing conditions. Command signals inputted by key operation on the keyboard, mouse operation, and button operation are outputted to the CPU 11. The operation unit 12 may be provided with a pressure sensitive type (resistance film pressure type) touch-panel, in which transparent electrodes are arranged in a grid on a display screen of the display unit 13, and outputs command signals inputted through the touch-panel to the CPU 11.

The operation unit 12 is an image selecting section through which a user selects an image to be displayed out of images stored in the memory unit 17.

The display unit 13 includes a display screen of an LCD (liquid crystal display), CRT (cathode ray tube), or the like, and displays various operation screens according to display controlling signals generated by CPU 11, and other various screens for results processed by CPU 11, and the like.

The communication unit 14 includes a communication interface, such as an NIC (network interface card) and a modem, and performs data communication with modalities connected to a communication network N, such as a CT apparatus 20, a CR apparatus 21, and an MRI apparatus 22, and the like. The communication unit 14 receives image data imaged by the modality. The communication unit 14 may receive from each modality not only image data but also supplemental information associated with each image data, such as a patient ID, information on the imaged region, information on the imaged date, and the like.

The ROM 15 stores programs and data for the image processing apparatus 10 in advance, therefore stores a system program, various kinds of processing programs for the system, and data necessary for processing in the various kinds of processing programs.

The RAM 16 stores various kinds of programs that are read out from the ROM 15 or the memory unit 17, and spread out into executable forms by the CPU 11. Further, the RAM 16 temporarily stores various kinds of data generated when CPU 11 executes programs.

The memory unit 17 is structured with rewritable nonvolatile storage media including magnetic storage media; such as HDD (hard disk drive), MRAM (magnetic random access memory, or flash memory; optical storage media; or semiconductor memories; and stores image data received from modalities, such as CT apparatus 20, CR apparatus 21, and MRI apparatus 22. Further, the memory unit 17 stores a plurality of different kinds of image processing conditions. The plurality of different kinds of image processing conditions include at least either of frequency processing conditions or tone processing conditions. Here, a plurality of image processing conditions with different image processing intensity are provided in advance for every imaged region of the image subject to the image processing.

A description will now be given for operation of the embodiment.

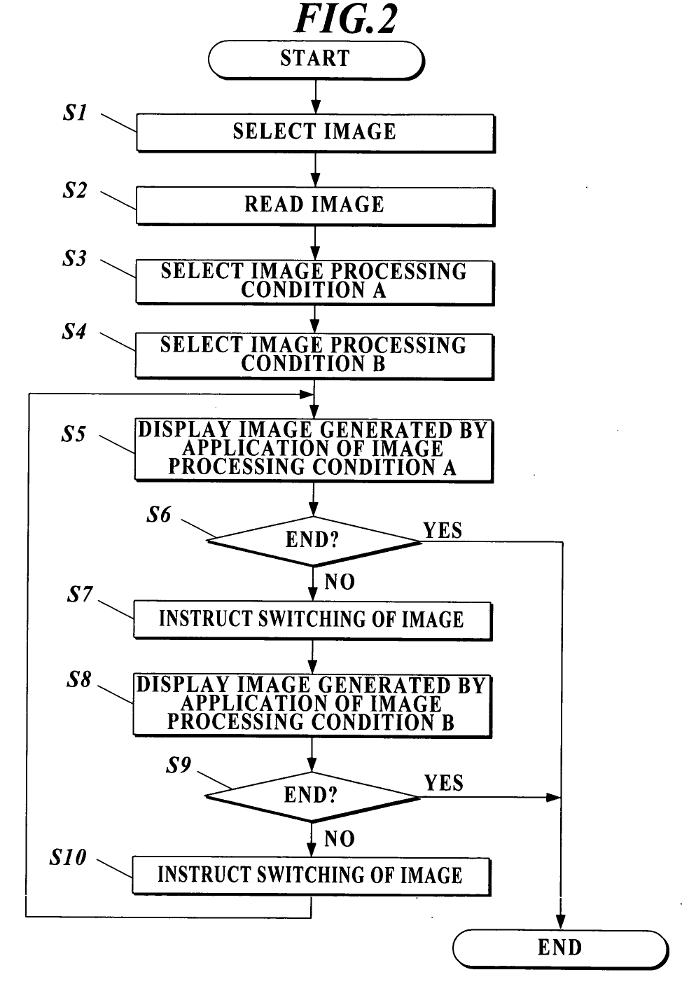

FIG. 2 is a flowchart showing an image displaying processing executed by the CPU 11 of the image processing apparatus 10. The processing is performed by software processing cooperated with the CPU 11 and an image displaying processing program stored in the ROM 15.

First of all, a list file of images stored in the memory unit 17 is displayed on the display unit 13, and a user selects an image to be displayed out of the listed image file through the operation unit 12 (step S1). The selected image is then read from the memory unit 17 (step S2).

Next, according to the imaged region of the selected image, an image processing condition A and an image processing condition B (different from the condition A) are selected out of the plurality of different kinds of image processing conditions (steps S3 and S4, respectively).

Subsequently, an image generated by image processing, under application of the image processing condition A to the selected image, is displayed on the display screen of the display unit 13 (step S5). The information presenting the processing condition A may be displayed on the display screen of the display unit 13 together with the image. In case of ending processing at this point (step S6; Yes), the processing is ended according to a command from the operation unit 12.

In case the process is not to be ended (step S6; No), the user depresses the switching button on the operation unit 12 to instruct switching of the image (step S7). According to the switching instruction, an image generated by image processing, under application of the image processing condition B to the selected image, is displayed on the display screen of the display unit 13 (step S8). The information presenting the processing condition B may be displayed on the display screen of the display unit 13 together with the image. In case of ending the processing at this point (step S9; Yes), the processing is ended according to a command from the operation unit 12.

In case the process is not to be ended (step S9; No), the user depresses the switching button on the operation unit 12 to instruct switching of the image (step S10). According to the switching instruction, the image generated by image processing, under application of the image processing condition A to the selected image, is displayed on the display screen of the display unit 13 (step S5).

Thus, according to the switching instruction from the switching button on the operation unit 12, image generated by image processing, under application of the image processing condition A to the selected image, and image generated by image processing, under application of the image processing condition B to the selected image, are sequentially switched and displayed on the display screen of the display unit 13.

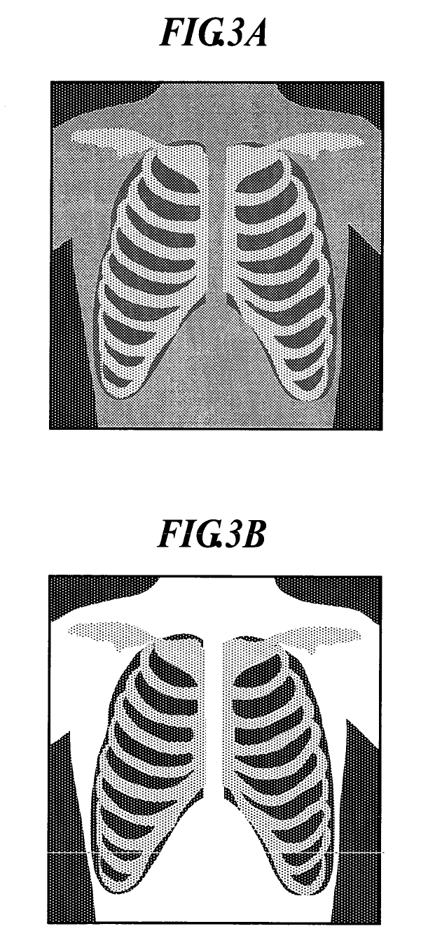

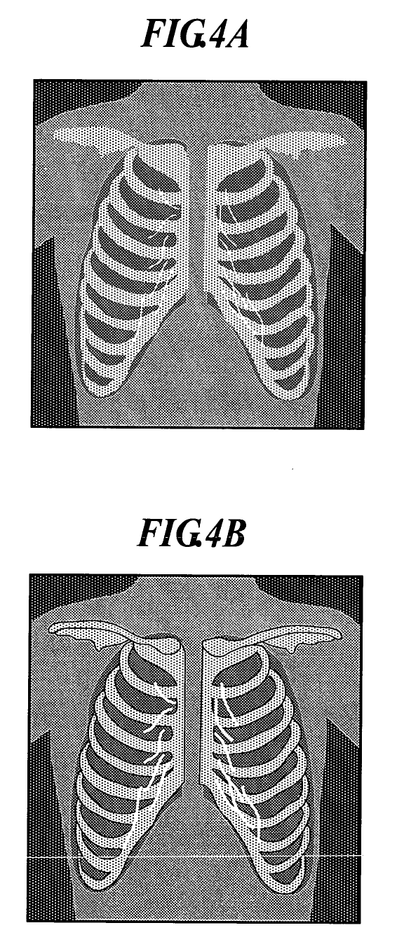

FIGS. 3A, 3B, 4A and 4B show examples of images generated by image processing, under different kinds of image processing conditions. FIGS. 3A and 3B are examples of images to which different tone processing conditions have been applied; FIG. 3A is that generated with application of weak tone processing, and FIG. 3B is that generated with application of strong tone processing. The difference between the tone processing conditions is presented with difference of gamma and shift between the images. The image shown in FIG. 3B has larger gradation difference and higher gamma, compared to the image shown in FIG. 3A.

FIGS. 4A and 4B are examples of images to which different frequency processing conditions have been applied; FIG. 4A is that generated with application of weak frequency processing, and FIG. 4B is that generated with application of strong frequency processing. The difference between the frequency processing conditions is presented with difference of the degree of enhanced edges of the image. The image shown in FIG. 4B has enhanced edges of the image, compared to the image shown in FIG. 4A.

As described above, the image processing apparatus 10 can execute image processing with application of a plurality of different kinds of image processing conditions to a selected image, switch each of the images generated by image processing, and display it on the same display screen of the display unit 13. Accordingly, a user can more easily recognize the difference between the images due to the difference between image processing conditions, and efficiency of image interpretation can be improved.

The description for the above embodiment is given as an example of the image processing apparatus according to the invention, but not limited to the embodiment. Various changes in each of detailed structure and operations configuring the image processing apparatus may be made, without deviation from the scope of the invention.

In the embodiment described above, the image processing conditions with different intensities of image processing are predetermined according to the imaged region of an image, but a user may selectively input image processing conditions to be used, out of the plurality of different kinds of image processing conditions stored in the memory unit 17, through the operation unit 12.

In the embodiment described above, the images applied with different image processing conditions with each other are switched and displayed based on a switching instruction from the switching button on the operation unit 12 by a user, but the images applied with different image processing conditions may be switched and displayed in a predetermined time interval.

In the embodiment described above, the images generated by image processing under two different image processing conditions were switched and displayed, but the images generated by image processing under three or more different image processing conditions may be exchanged and displayed.

The image processing apparatus 10 receives image data imaged by the modalities, such as CT apparatus 20, CR apparatus 21, and MRI apparatus 22, which are connected to the communication network N, but an image processing apparatus may include within itself an image generating apparatus.

In the image processing apparatus 10, the communication unit 14 and the memory unit 17 may be separately provided from a main body of the image processing apparatus.

The entire disclosure of Japanese Patent Application No. 2005-97781 which was filed on Mar. 30, 2005 is incorporated into the present invention in its entirety.

What is claimed is:

1. An image processing apparatus comprising:
an image storing section to store images imaged by modalities;
an image selecting section to allow a user to select an image to be displayed out of images stored in the image storing section;
an image processing condition storing section to store a plurality of different kinds of image processing conditions;
an image processing section to execute image processing by application of the plurality of different kinds of image processing conditions to selected image; and
a display controlling section to switch each of images generated by image processing, under application of the plurality of different kinds of image processing conditions to the selected image, and to display it on the same display screen.

2. The image processing apparatus of claim 1, wherein the plurality of different kinds of image processing conditions comprise at least either of frequency processing conditions or tone processing conditions.

3. The image processing apparatus of claim 1, further comprising an image processing condition inputting section to allow the user to selectively input image processing conditions to be used out of the plurality of different kinds of image processing conditions.

4. The image processing apparatus of claim 1, further comprising a switching instruction section to instruct switching of each of the images generated by image processing, wherein the display controlling section switches each of the images generated by image processing based on a switching instruction from the switching instruction section and displays it on the same display screen.

5. The image processing apparatus of claim 1, wherein the display controlling section switches each of the images generated by image processing in a predetermined time interval and displays it on the same display screen.

6. An image processing method comprising:
an image storing step to store images imaged by modalities;
an image selecting step to allow a user to select an image to be displayed out of stored images;
an image processing condition storing step to store a plurality of different kinds of image processing conditions;
an image processing step to execute image processing by application of the plurality of different kinds of image processing conditions to selected image; and
a display controlling step to switch each of images generated by image processing, under application of the plurality of different kind of image processing conditions to the selected image, and to display it on the same display screen.

7. The image processing method of claim 6, wherein the plurality of different kinds of image processing conditions comprise at least either of frequency processing conditions or tone processing conditions.

8. The image processing method of claim 6, further comprising an image processing condition inputting step to allow the user to selectively input image processing conditions to be used out of the plurality of different kinds of image processing conditions.

9. The image processing method of claim 6, wherein at the display controlling step, each of the images generated by image processing is displayed on the same display screen within switching, based on a switching instruction from a switching instruction section that instructs switching of each of the images generated by image processing.

10. The image processing method of claim 6, wherein at the display controlling step, each of the images generated by image processing is switched in a predetermined time interval and displayed on the same display screen.

11. An image processing program that causes a computer to execute a process comprising:
an image selecting step to allow a user to select an image to be displayed out of images imaged by modalities and stored in an image storing section;
an image processing step to execute image processing by application of a plurality of different kinds of image processing conditions stored in an image processing condition storing section to the selected image; and
a display controlling step to switch each of images generated by image processing, under application of the plurality of different kinds of image processing conditions to the selected image, and to display it on the same display screen.

12. The image processing program of claim 11, wherein the plurality of different kinds of image processing conditions comprise at least either of frequency processing conditions or tone processing conditions.

13. The image processing program of claim 11, wherein the process further comprises an image processing condition inputting step to allow the user to selectively input image processing conditions to be used out of the plurality of different kinds of image processing conditions.

14. The image processing program of claim 11, wherein at the display controlling step, each of the images generated by image processing are displayed on the same display screen within switching, based on a switching instruction from a switching instruction section that instructs switching of each of the images generated by image processing.

15. The image processing program of claim 11, wherein at the display controlling step, each of the images generated by image processing is switched in a predetermined time interval and displayed on the same display screen.
